(19) United States
(12) Patent Application Publication
(10) Pub. No.: US 2026/0039765 A1
(43) Pub. Date: Feb. 5, 2026

(54) EFFECT RENDERING METHOD, ELECTRONIC DEVICE, AND MEDIUM

(71) Applicants: Beijing Zitiao Network Technology Co., Ltd., Beijing (CN); Lemon Inc., Grand Cayman (KY)

(72) Inventors: Qinggai HUANG, Beijing (CN); Nite LUO, Los Angeles, CA (US); Nathan SHANGKALA, Los Angeles, CA (US); Eric CHANG, Los Angeles, CA (US); Xinglun LIANG, Beijing (CN); Han SUN, Los Angeles, CA (US); Nikhil PURUSHE, Los Angeles, CA (US)

(21) Appl. No.: 19/253,625

(22) Filed: Jun. 27, 2025

(30) Foreign Application Priority Data
Aug. 2, 2024 (CN) 202411061003.6

(51) Int. Cl. H04N 5/262

(52) U.S. Cl. CPC H04N 5/262

(57) ABSTRACT

The present disclosure provides an effect rendering method and apparatus, an electronic device, a storage medium, and a program product, the method includes obtaining an image and a first effect rendering mode, in which the first effect rendering mode is configured to specify a number of a base image and an identifier of the base image corresponding to first effect rendering, a number of a channel and a first channel identifier of each first rendering node of the first effect rendering, and a corresponding relationship between the first channel identifier and the identifier of the base image; generating a plurality of first base images based on the image and the number of the base image, and identifying the first base images in one-to-one correspondence through the identifiers of the base images; binding the channel of each first rendering node to a corresponding first base image.

### CROSS-REFERENCE TO RELATED APPLICATION

The present application claims the priority to Chinese Patent Application No. 202411061003.6, filed on Aug. 2, 2024, the entire disclosure of which is incorporated herein by reference as portion of the present application.

### TECHNICAL FIELD

The present disclosure relates to an effect rendering method and apparatus, an electronic device, a storage medium, and a program product.

### BACKGROUND

In some video effects scenes, it is desirable to display different effects in the preview interface of the video shooting and the playback interface of the recording results. For example, the specified prompt words and buttons are displayed in the shooting preview interface, and the specified prompt words and buttons are hidden in the playback interface of the recording results.

At present, the above video effects requirements are realized based on BEFView technology, but this technology requires the creation of two effects and the use of event.lua to make the two effects communicate. This technology has high performance requirements for the video recording equipment, and the equipment coverage rate is not high.

Therefore, there is an urgent need for a method that can improve equipment coverage.

### SUMMARY

The present disclosure provides an effect rendering method, an effect rendering apparatus, an electronic device, a non-transitory computer-readable storage medium and a computer program product.

In a first aspect, the present disclosure provides an effect rendering method, and the method comprises:

obtaining an image and a first effect rendering mode, in which the first effect rendering mode is configured to specify a number of a base image and an identifier of the base image corresponding to first effect rendering, a number of a channel and a first channel identifier of each first rendering node of the first effect rendering, and a corresponding relationship between the first channel identifier and the identifier of the base image;

generating a plurality of first base images based on the image and the number of the base image, and identifying the first base images in one-to-one correspondence through the identifiers of the base images;

binding the channel of each first rendering node to a corresponding first base image according to the corresponding relationship between the first channel identifier and the identifier of the base image;

performing effect rendering on the bound first base image based on a corresponding channel of the first rendering node to obtain a rendering result.

In a second aspect, the present disclosure provides an effect rendering apparatus, which comprises:

a data acquisition module, configured to obtain an image and a first effect rendering mode, in which the first effect rendering mode is configured to specify a number of a base image and an identifier of the base image corresponding to first effect rendering, a number of a channel and a first channel identifier of each first rendering node of the first effect rendering, and a corresponding relationship between the first channel identifier and the identifier of the base image;

a first base image generation module, configured to generate a plurality of first base images based on the image and the number of the base image, and identify the first base images in one-to-one correspondence through the identifiers of the base images;

a first base image binding module, configured to bind the channel of each first rendering node to a corresponding first base image according to the corresponding relationship between the first channel identifier and the identifier of the base image;

an effect rendering module, configured to perform effect rendering on the bound first base image based on a corresponding channel of the first rendering node to obtain a rendering result.

In a third aspect, the present disclosure provides an electronic device including a memory and a processor. The memory and the processor are in communication connection with each other. The memory stores computer instructions. The processor executes the computer instructions to perform the effect rendering method according to the first aspect.

In a fourth aspect, the present disclosure provides a computer-readable storage medium having computer instructions stored thereon. The computer instructions are used to enable a computer to perform the effect rendering method according to the first aspect.

In a fifth aspect, the present disclosure provides a computer program product including computer instructions. The computer instructions are used to enable a computer to perform the effect rendering method according to the first aspect.

### BRIEF DESCRIPTION OF DRAWINGS

To illustrate the technical solutions in the embodiments of the present disclosure more clearly, the drawings that are required to be used in the description of the specific embodiments will be briefly introduced below. Obviously, the drawings in the following description are some embodiments of the present disclosure. For those of ordinary skills in the art, other drawings can also be obtained from these drawings without creative efforts.

FIG. 1 is a schematic diagram of an original interface of some video recordings;

FIG. 2 is an effect interface diagram of some video recording interfaces;

FIG. 3 is an effect interface diagram of a playback interface of some recording results;

FIG. 4 is a schematic flow diagram of an effect rendering method according to at least one embodiment of the present disclosure.

FIG. 5 is a flowchart of rendering effect in some base images according to at least one embodiment of the present disclosure;

FIG. 6 is a flowchart of rendering effect in other base images according to at least one embodiment of the present disclosure;

FIG. 7 is a schematic flow diagram of rendering effect in a base image based on the channel according to at least one embodiment of the present disclosure;

FIG. 8 is a schematic diagram of a new flow obtained by reversing the effect rendering flow in FIG. 7;

FIG. 9 is a schematic diagram of a comprehensive sorting of a first rendering node and a second rendering node according to at least one embodiment of the present disclosure.

FIG. 10 is a schematic diagram of another comprehensive sorting of a first rendering node and a second rendering node according to at least one embodiment of the present disclosure.

FIG. 11 is a schematic diagram of a module of an effect rendering apparatus provided by at least one embodiment of the present disclosure;

FIG. 12 is a schematic structural diagram of an electronic device provided by at least one embodiment of the present disclosure.

### DETAILED DESCRIPTION

To make the objectives, technical solutions, and advantages of the embodiments of the present disclosure clearer, the technical solutions in the embodiments of the present disclosure will be described clearly and comprehensively below with reference to the drawings in the embodiments of the present disclosure. Obviously, the described embodiments are part of the embodiments of the present disclosure, but not all of them. Based on the embodiments in the present disclosure, all other embodiments obtained by those of ordinary skills in the art without creative efforts shall fall within the protection scope of the present disclosure.

Embodiments of the present disclosure are described in more detail below with reference to the drawings. Although certain embodiments of the present disclosure are shown in the drawings, it should be understood that the present disclosure may be achieved in various forms and should not be construed as being limited to the embodiments described here. On the contrary, these embodiments are provided to understand the present disclosure more clearly and completely. It should be understood that the drawings and the embodiments of the present disclosure are only for exemplary purposes and are not intended to limit the scope of protection of the present disclosure.

In the description of the embodiments of the present disclosure, the term “including” and similar terms should be understood as open-ended inclusion, that is, “including but not limited to”. The term “based” should be understood as “based at least in part”. The term “one embodiment' or “the embodiment” should be understood as “at least one embodiment”. The term “some embodiments” should be understood as “at least some embodiments”. The following text may also include other explicit and implicit definitions.

In this article, unless explicitly stated, “performing a step in response to A” does not mean that the step is performed immediately after “A”, but may include one or more intermediate steps.

It can be understood that, the data (including but not limited to the data itself, its acquisition, use, storage, or deletion) involved in the technical solution should comply with the requirements of corresponding laws and regulations and relevant regulations.

It can be understood that, before using the technical solutions disclosed in each embodiment of the present disclosure, relevant users should be informed of the types, scope of use, usage scenarios and so on of the information involved in the present disclosure in an appropriate manner in accordance with relevant laws and regulations, and authorization from relevant users should be obtained, and the relevant users may include any type of right subject, such as individuals, enterprises, and groups.

For example, in response to receiving an active request from the user, prompt information is transmitted to the relevant user to explicitly prompt the relevant user that the operation requested by the relevant user requires obtaining and using information of the relevant user, so that the relevant user can autonomously select whether to provide information to software or hardware such as an electronic device, an application, a server, or a storage medium that performs the operation of the technical solution of the present disclosure according to prompt information.

As an optional but non-limiting implementation, in response to receiving an active request from the relevant user, a manner in which prompt information is transmitted to the relevant user, for example, it could be in the form of a pop-up window, and the pop-up window can present prompt information in the form of text. In addition, the pop-up window can also carry a selection control for users to choose “agree” or “disagree” to provide information to the electronic device.

It is to be understood that, the above-described procedures of notifying and obtaining user authorization are merely illustrative and do not limit the implementation forms of the present disclosure, and other methods satisfying relevant laws and regulations may also be applied to the implementation forms of the present disclosure.

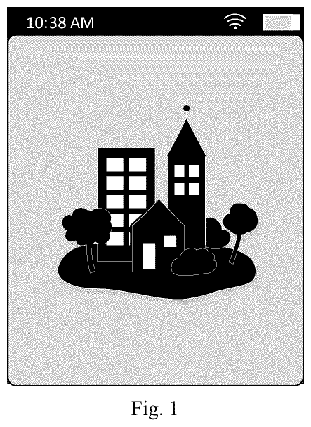

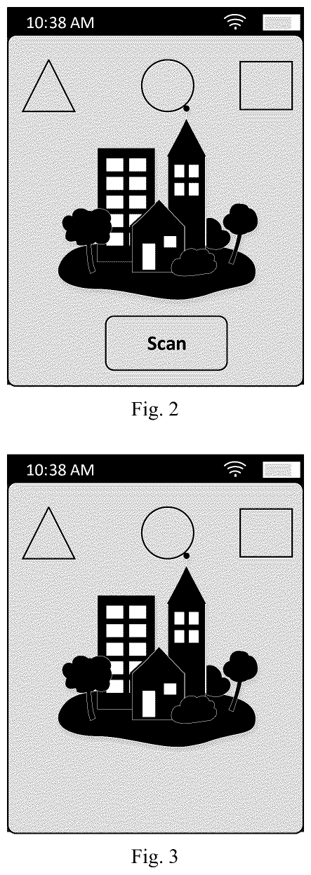

With the development of technology, it is necessary to display different effects in the video recording interface and the playback interface of the recording results. For example, suppose that FIG. 1 is a schematic diagram of an original interface of some video recordings. If it is required to rendering the effects of circle, square, triangle and scan button in the video recording interface, then the schematic diagram of the effect interface of the video recording interface shown in FIG. 2 can be obtained; if it is required to rendering the effects of circle, square and triangle in the playback interface of recording results and hide the scan button, then the schematic diagram of the effects interface of the video playback interface shown in FIG. 3 can be obtained.

Currently, the above effects requirements are implemented based on BEFView technology, but this technology requires creating two effects and using event.lua to make the two effects communicate. This technology requires high performance of the video recording equipment, and the equipment coverage rate is not high.

In view of this, the present disclosure provides an effect rendering method, which can reduce the performance requirements of the video recording device and improve the coverage rate of the device. The effect rendering method can be applied to an electronic device. The electronic device includes, but is not limited to, tablets, laptops, desktop computers, servers, etc. Hereinafter, the effect rendering method of the present disclosure will be described by taking a scene of video recording as an example.

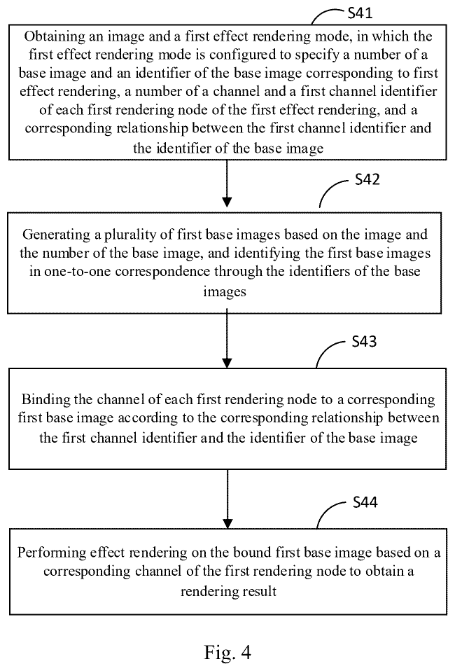

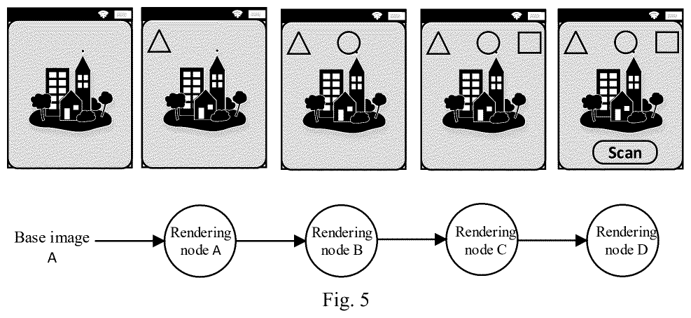

Referring to FIG. 4, FIG. 4 is a schematic flow diagram of an effect rendering method according to at least one embodiment of the present disclosure. In FIG. 4, the effect rendering method may include the following steps:

Step S41: obtaining an image and a first effect rendering mode, in which the first effect rendering mode is configured to specify a number of a base image and an identifier of the base image corresponding to first effect rendering, a number of a channel and a first channel identifier of each first rendering node of the first effect rendering, and a corresponding relationship between the first channel identifier and the identifier of the base image.

In the present embodiment, the image may include an original interface diagram (which may also be referred to as a video frame image) during video recording.

In the present embodiment, based on different effect requirements, a plurality of base images can be generated from the video frame image, and different effects are rendered in each of the base images to obtain a plurality of different effect interface diagrams. Among the obtained effect interface diagrams, some effect interface diagrams can be used to display in the video recording interface; some effect interface diagrams can be saved locally in the electronic device for displaying in the playback interface of the recorded results.

For example, taking the video frame image shown in FIG. 1 as an example. Two base images of a base image A and a base image B identical to the original interface diagram can be generated based on the original interface diagram shown in FIG. 1. Rendering the effects of circle, square, triangle and scan button in the base image A, and the effect interface diagram for displaying in the video recording interface can be obtained. Rendering the effects of circle, square and triangle in the base image B, and the effect interface diagram for displaying in the playback interface of the recorded results can be obtained. The effect rendering of the base image A and the effect rendering of the base image B may be completed during the video recording process, and, during the video recording process, the effect interface diagram of the base image A may be displayed, and the effect interface diagram of the base image B may be saved locally in the electronic device. When the video recording is completed and the recording result needs to be played, the effect interface diagram of the base image B can be displayed in the playing interface of the recording result.

The operation of the rendering effect in each of the base images is completed by rendering nodes.

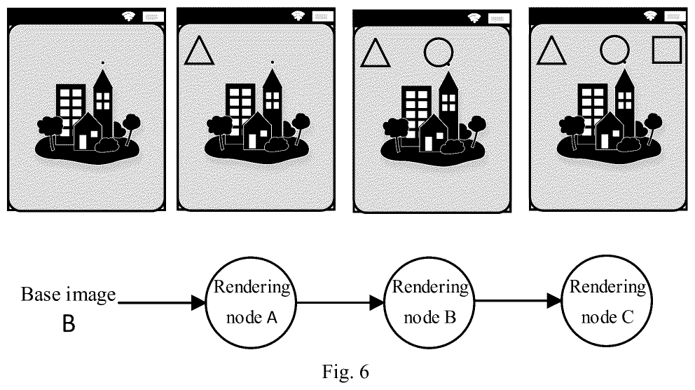

In the present embodiment, each of the rendering nodes can be used to rendering one effect in the base image, and different rendering nodes can be used to render different effects. A plurality of rendering nodes can be sequentially applied to the base images to render effects, then a final effect interface image can be obtained. For example, still taking FIG. 1 to FIG. 3 as examples. Referring to FIG. 5, FIG. 5 is a flowchart of rendering effect in some base images according to at least one embodiment of the present disclosure. In FIG. 5, it is assumed that the rendering node A can render the triangle effect, the rendering node B can render the circle effect, the rendering node C can render the square effect, and the rendering node D can render the scan button effect, so that after the rendering nodes A, B, C, and D sequentially render the effects into the base image A, the effect interface diagram for displaying in the video recording interface can be obtained. Similarly, referring to FIG. 6, FIG. 6 is a flowchart of rendering effect in other base images according to at least one embodiment of the present disclosure. In FIG. 6, it is assumed that rendering node A can render triangle effect, the rendering node B can render circle effect, and the rendering node C can render square effect, so that after the rendering nodes A, B, C, and D sequentially render the effects into the base image B, the effect interface diagram for displaying in the playback interface of the recorded result can be obtained.

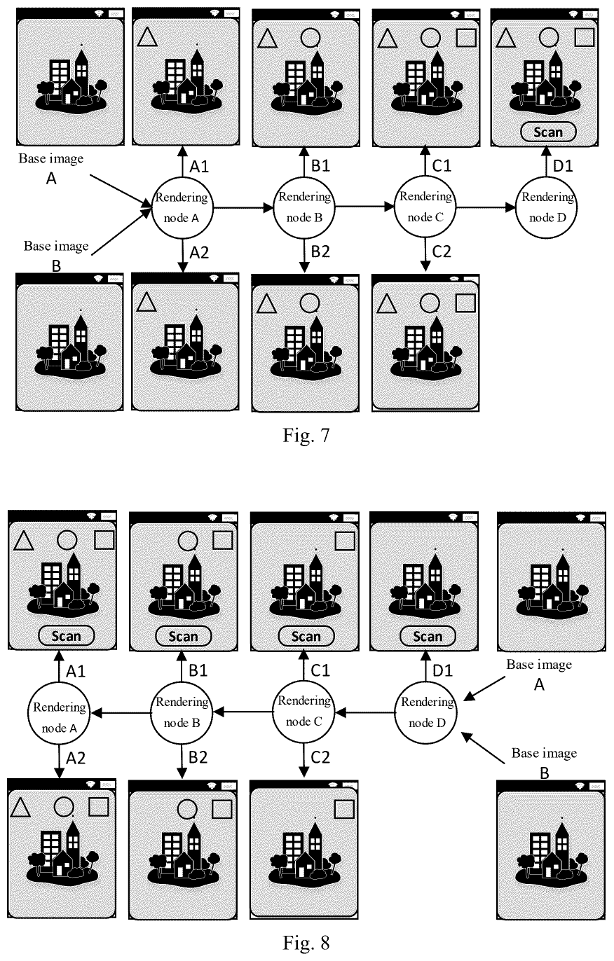

In the present embodiment, the rendering node may have one or more channels, and each channel may be bound to one base image, respectively. Based on each channel of the rendering node, effect can be rendered to the base image bound to the channel. For convenience of understanding, referring to FIG. 7, FIG. 7 is a schematic flow diagram of rendering effect in a base image based on the channel according to at least one embodiment of the present disclosure. In FIG. 7, it is assumed that the rendering node A can render the triangle effect, the rendering node B can render the circle effect, the rendering node C can render the square effect, and the rendering node D can render the scan button effect. In order to obtain the effect interface diagrams in FIG. 5 and FIG. 6, two channels A1 and A2 can be set for the rendering node A, and the channel A1 is bound to the base image A, and the channel A2 is bound to the base image B; the rendering node B is provided with two channels B1 and B2, and the channel B1 is bound to the base image A, and the channel B2 is bound to the base image B; the rendering node C is provided with two channels C1 and C2, and the channel C1 is bound to the base image A, and the channel C2 is bound to the base image B; the rendering node D is provided with a channel D1, and the channel D1 is bound to the base image A.

In this way, based on the channel A1 of the rendering node A, the triangle effect can be rendered to the base image A, and based on the channel A2 of the rendering node A, the triangle effect can be rendered to the base image B;

Based on the channel B1 of the rendering node B, the circle effect can be rendered to the base image B, and based on the channel B2 of the rendering node B, the circle effect can be rendered to the base image B;

Based on the channel C1 of the rendering node C, the square effect can be rendered to the base image A, and based on the channel C2 of the rendering node C, the square effect can be rendered to the base image B;

Based on the channel D1 of the rendering node D, the scan button effect can be rendered in the base image A.

Thus, the effect interface diagrams in FIG. 5 and FIG. 6 are obtained.

Based on FIG. 7, it can be understood that by controlling the number of the channel of the rendering nodes and the base image bound to each channel, different effect interface diagrams can be obtained based on a set of rendering nodes.

In the present embodiment, the identifier of the base image may be set for each base image, and the identifiers of the base images of different base images are different. A channel identifier may be set for the channel of the rendering node, and different channels of the same rendering node may have different channel identifiers. A correspondence relationship for the channel identifier and the base image identifier can be arranged. Based on the correspondence relationship between the channel identifier and the identifier of the base image, the base image bound to the channel of each rendering node can be controlled.

To sum up, it is understandable that, by specifying the number of the base image, the number of the effect interface diagrams in the image can be controlled; by specifying the rendering node used for rendering effect, the number of the channel of each rendering node, and the corresponding relationship between the channel identifier and the identifier of the base image, the effect content in each effect interface diagram can be controlled respectively. Taking a video recording scene as an example, the number of the base images can be 2. In this way, it is possible to rendering different effects in the video recording screen and the playback screen of the recording results.

In the present embodiment, the corresponding relationship between the number of the base image and the identifier of the base image to be specified in the effect rendering process, the number of the channel and the channel identifier of the rendering node, and the channel identifier and the base image identifier can be characterized by the effect rendering method. Different effect rendering modes can represent different designated contents, so that the number of the effect interface diagrams obtained based on different effect rendering modes, effect contents in each effect interface and so on, may not be exactly the same.

In the present embodiment, one or more predefined effect rendering modes may be displayed in the interface before video recording. Video recorders can choose effect rendering modes according to actual needs. In response to the selection operation of the video recorder, the selected effect rendering mode may be used as the first effect rendering mode in step S41. At the same time, during the video recording process, the recorded original video frame image is used as the image.

In step S42: generating a plurality of first base images based on the image and the number of the base image, and identifying the first base images in one-to-one correspondence through the identifiers of the base images.

Specifically, a plurality of first base images can be copied from an image according to the number of the base image. For example, in a case where the number of the base images is 2, two first base images can be copied from the image. Each of the first base images is the same as the image. After the first base images are obtained, the first base images may be identified in one-to-one correspondence using the identifiers of the base images designated in the first effect rendering mode.

Step S43: binding the channel of each first rendering node to a corresponding first base image according to the corresponding relationship between the first channel identifier and the identifier of the base image.

The principle of this step can refer to the relevant description of step S41, which will not be repeated herein.

Step S44: performing effect rendering on the bound first base image based on a corresponding channel of the first rendering node to obtain a rendering result.

Specifically, based on any channel of the first rendering node, the effect rendering may be performed on the first base image bound to the channel. For example, based on the channel A of the first rendering node, the effect rendering may be performed on the first base image bound to the channel A; based on the channel B of the first rendering node, the effect rendering may be performed on the first base image bound to the channel B. In this way, the effect content in each first base image can be controlled, so that different effects can be displayed in different interfaces.

In summary, in the technical solution of some embodiments of the present application, on the one hand, based on the number of the base image and the identifier of the base image specified by the first effect rendering mode, the number of the channel of each first rendering node and the first channel identifier, and the corresponding relationship between the first channel identifier and the identifier of the base image, the first base image bound to the rendering node can be controlled, and then the effect content in each first base image can be controlled, thereby achieving the purpose of displaying different effects in different interfaces. On the other hand, the present disclosure achieves the display of different effects in different interfaces by controlling the binding relationship between rendering and each of the first base images, without the need for communication between effects, thereby reducing the performance requirements of the video recording equipment and improving the equipment coverage of the technology.

Referring to FIG. 7, the rendering node A is taken as an example. Based on the channel A1 and the channel A2 of the rendering node A, the effects rendering in the base image are the same (both are the triangle effects in rendering). Since the first base images of the present disclosure are the same, it can be understood that, after performing effect rendering on the base image A based on the channel Al of the rendering node A and performing effect rendering on the base image B based on the channel BI of the rendering node B, the base image A and the base image B after the effect rendering are still the same.

For the sake of reducing resource consumption, in some embodiments, in response to the first rendering node comprising a first channel and a second channel other than the first channel, the performing effect rendering on the bound first base image based on a corresponding channel of the first rendering node comprises:

performing effect rendering on a first base image bound to the first channel based on the first channel;

stopping effect rendering on a first base image bound to the second channel based on the second channel;

copying the first base image bound to the first channel, and using a copied first base image as a first base image obtained by performing effect rendering on the first base image bound to the second channel based on the second channel;

replacing the first base image bound to the second channel with the copied first base image.

For example, the rendering node A of FIG. 7 is taken as an example. The effect rendering is performed on the base image A based on the channel Al and the effect rendering on the base image B based on the channel A2 may be stopped. After the effect rendering on the base image A based on the channel A1, the base image A (i.e., the base image A including the triangle effects) after the effect rendering can be copied, and then the copied base image A can be replaced with the base image B bound to the channel A2.

In this way, in the effect rendering process, the second channel may not be invested in effect rendering, thereby reducing the resource consumption of the effect rendering based on the second channel, and further reducing the performance requirements of the device.

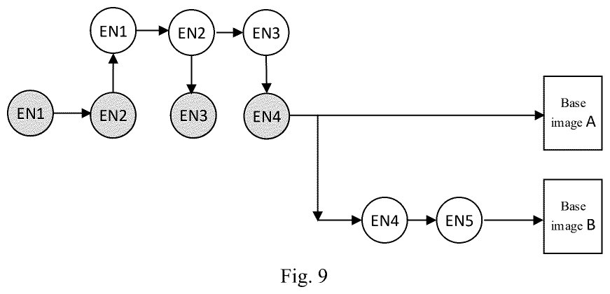

However, the scheme of replicating through the first base image will also have some problems. For example, referring to FIG. 8, FIG. 8 is a schematic diagram of a new flow obtained by reversing the effect rendering flow in FIG. 7. Compared with FIG. 7, the main difference between FIG. 8 and FIG. 7 is that the effect rendering is performed according to the process of the rendering node A>the rendering node B>the rendering node C >the effect rendering node D. FIG. 8 shows the rendering according to the process of the rendering node D>the rendering node C>the rendering node B>the rendering node A. In FIG. 8, firstly, the unique scan button in the base image A is effect rendering on the base image A. In this case, in the case where the effect rendering is performed on the bound first base image based on the channel of the rendering node C, if:

the effect rendering is performed on the base image A based on the channel C1;

the effect rendering is stopped on the base image B based on channel C2;

the base image A bound to the channel C1 is copied and the base image B bound to the channel

C2 is replaced with the copied base image A.

Obviously, it can be seen that, under the effect rendering process, the unique scan button in the base image A is copied to the base image B.

In order to solve the above problem, in some embodiments, in response to the first rendering node comprising a first rendering child node and a second rendering child node, and a number of a channel of the first rendering child node being greater than a number of a channel of the second rendering child node (that is the first base image bound to the channel of the first rendering child node is more than the first base image bound to the channel of the second rendering child node), the performing effect rendering on the bound first base image based on a corresponding channel of the first rendering node comprises:

after performing effect rendering on the bound first base image based on a corresponding channel of the first rendering child node, performing effect rendering on the bound first base image based on a corresponding channel of the second rendering child node.

Referring to FIG. 7 and FIG. 8 in conjunction. Rendering nodes A, B, C, and D may be first rendering nodes, in which the rendering nodes A, B, and C may be first rendering child nodes, and the rendering node D may be a second rendering child node. In the above embodiment, firstly, the effect rendering is performed on the bound first base image based on the channel of the first rendering child node, and then the effect rendering is performed on the bound first base image based on the channel of the second rendering child node, which can be understood as: firstly the common effect is rendered on all of the first base images, and then the unique effect is rendered on some of the first base images. In this way, when performing effect rendering based on the method of copying the first base image, it can effectively avoid copying the unique effect of some of the first base images to other first base images.

In some embodiments, it is considered that in some scenarios, when the effect rendering is performed on the first base image based on the first effect rendering mode selected by the video recording user, there may also be some default second effect rendering mode. That is, it is necessary to perform the effect rendering on the first base image based on the first effect rendering mode and the second effect rendering mode at the same time. In view of this, the method of the present disclosure may further comprise:

obtaining a second effect rendering mode, in which the second effect rendering mode is configured to specify each second rendering node of second effect rendering;

binding a channel of the second rendering node to at least a portion of the first base images;

performing effect rendering on the bound first base image based on the channel of the second rendering node.

Specifically, the second effect rendering mode may specify only each second rendering node of the second effect rendering, and do not specify the corresponding relationship between the number of the base image and the identifier of the base image, the number of the channel and the channel identifier of the second rendering node, and the channel identifier and the identifier of the base image, and the second effect rendering node designated by the second rendering mode may be different from the first rendering node. For example, the first rendering node is used for rendering triangle, square, circle, and scan button effects on the first base image, and the second rendering node is used for rendering smiling a face effect on the first base image. In this way, by binding the channel of the second rendering node to at least a portion of the first base images, a new effect can be added to at least a portion of the first base images through the second rendering node.

Specifically, in some embodiments, the binding a channel of the second rendering node to at least a portion of the first base images comprises:

in response to the second effect rendering mode not specifying a number of a channel and a second channel identifier of each second rendering node, and a corresponding relationship between the second channel identifier and the identifier of the base image, binding the channels of the second rendering node in one-to-one correspondence with all of the first base images.

In this way, it is possible to ensure that the effect rendering on the second rendering node is applied to all of the first base images.

Further, in order to avoid the unique effect of the first base image rendering on the other first base images, the first rendering node and the second rendering node can reperform comprehensive rendering sorting to ensure that the effect common to all of the first base images is rendered in the front, and the unique effect of some first base images is rendered in the back. For convenience of understanding, referring to FIG. 9, FIG. 9 is a schematic diagram of a comprehensive sorting of a first rendering node and a second rendering node according to at least one embodiment of the present disclosure. In FIG. 9, it is assumed that the white node is the first rendering node and the gray node is the second rendering node. It is assumed that the channels of the first rendering nodes EN1 to EN3 are bound to all of the first base images in one-to-one correspondence, and the channels of the first rendering nodes EN4 to EN5 are bound to some of the first base images. Since the channels of the second rendering node are bound to all of the first base images in one-to-one correspondence, when the first rendering node and the second rendering node are comprehensively sorted, the first rendering nodes EN1 to EN3 and the second rendering nodes EN1 to EN4 need to be ranked first, and the first rendering nodes EN4 to EN5 need to be ranked behind. In this manner, the ranking diagram shown in FIG. 9 is obtained.

Based on the above description, in a case where the channels of the second rendering node and all of the first base images are bound in one-to-one correspondence, since the number of the channels of the second rendering child node is relatively small, the above-described the performing effect rendering on the bound first base image based on the channels of the second rendering node comprises:

after performing effect rendering on the bound first base image based on the channel of the second rendering node, performing effect rendering on the bound first base image based on a corresponding channel of the second rendering child node.

In this way, it is ensured that the effect common to all of the first base images is rendered in the front, and the unique effect of some first base images is rendered in the back.

In some embodiments, in response to the second effect rendering mode having specified a number of a channel and a second channel identifier of each second rendering node, and a corresponding relationship between the second channel identifier and the identifier of the base image, the channel of the each second rendering node is bound to a corresponding first base image according to the corresponding relationship between the second channel identifier and the identifier of the base image. The related principle is similar to the first rendering node, which will not be repeated herein.

Similarly, in response to the second rendering node comprising a third rendering child node, and a number of a channel of the third rendering child node being greater than the number of the channel of the second rendering child node, the performing effect rendering on the bound first base image based on the channel of the second rendering node comprises:

after performing effect rendering on the bound first base image based on a corresponding channel of the third rendering child node, performing effect rendering on the bound first base image based on the corresponding channel of the second rendering child node.

in response to the second rendering node comprising a fourth rendering child node, and a number of a channel of the fourth rendering child node being less than the number of the channel of the first rendering child node, the performing effect rendering on the bound first base image based on the channel of the second rendering node comprises:

after performing effect rendering on the bound first base image based on a corresponding channel of the first rendering child node, performing effect rendering on the bound first base image based on the corresponding channel of the fourth rendering child node.

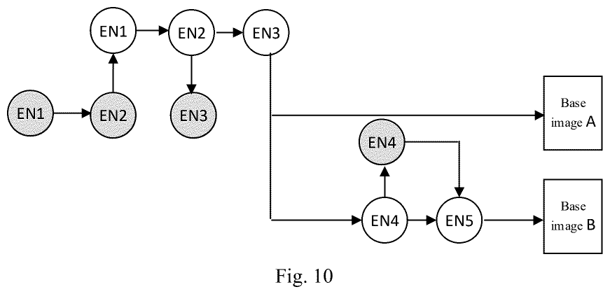

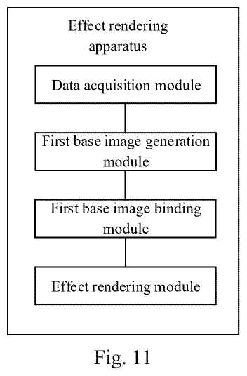

For convenience of understanding, referring to FIG. 10, FIG. 10 is a schematic diagram of another comprehensive sorting of a first rendering node and a second rendering node according to at least one embodiment of the present disclosure. FIG. 9 and FIG. 10 are basically similar. The main difference is that, the second rendering node EN4 with less number of channels, is ranked behind.

Corresponding to the effect rendering method, the present disclosure further provides an effect rendering apparatus. Referring to FIG. 11, FIG. 11 is a schematic diagram of a module of an effect rendering apparatus provided by at least one embodiment of the present disclosure. In FIG. 11, the effect rendering apparatus comprises:

a data acquisition module, configured to obtain an image and a first effect rendering mode, in which the first effect rendering mode is configured to specify a number of a base image and an identifier of the base image corresponding to first effect rendering, a number of a channel and a first channel identifier of each first rendering node of the first effect rendering, and a corresponding relationship between the first channel identifier and the identifier of the base image;

a first base image generation module, configured to generate a plurality of first base images based on the image and the number of the base image, and identify the first base images in one-to-one correspondence through the identifiers of the base images;

a first base image binding module, configured to bind the channel of each first rendering node to a corresponding first base image according to the corresponding relationship between the first channel identifier and the identifier of the base image;

an effect rendering module, configured to perform effect rendering on the bound first base image based on a corresponding channel of the first rendering node to obtain a rendering result.

In some embodiments, in response to the first rendering node comprising a first channel and a second channel other than the first channel, the effect rendering module is specifically configured to:

perform effect rendering on a first base image bound to the first channel based on the first channel;

stop effect rendering on a first base image bound to the second channel based on the second channel;

copy the first base image bound to the first channel, and using a copied first base image as a first base image obtained by performing effect rendering on the first base image bound to the second channel based on the second channel;

replace the first base image bound to the second channel with the copied first base image.

In some embodiments, in response to the first rendering node comprising a first rendering child node and a second rendering child node, and a number of a channel of the first rendering child node being greater than a number of a channel of the second rendering child node, the effect rendering module is specifically configured to:

after performing effect rendering on the bound first base image based on a corresponding channel of the first rendering child node, perform effect rendering on the bound first base image based on a corresponding channel of the second rendering child node.

In some embodiments, the effect rendering module is further configured to:

obtain a second effect rendering mode, in which the second effect rendering mode is configured to specify each second rendering node of second effect rendering;

bind a channel of the second rendering node to at least a portion of the first base images;

perform effect rendering on the bound first base image based on the channel of the second rendering node.

In some embodiments, the effect rendering module is specifically used to:

in response to the second effect rendering mode not specifying a number of a channel and a second channel identifier of each second rendering node, and a corresponding relationship between the second channel identifier and the identifier of the base image, bind the channels of the second rendering node in one-to-one correspondence with all of the first base images.

In some embodiments, the effect rendering module is specifically used to:

after performing effect rendering on the bound first base image based on the channel of the second rendering node, perform effect rendering on the bound first base image based on the corresponding channel of the second rendering child node.

In some embodiments, the effect rendering module is specifically used to:

in response to the second effect rendering mode having specified a number of a channel and a second channel identifier of each second rendering node, and a corresponding relationship between the second channel identifier and the identifier of the base image, bind the channel of the each second rendering node to a corresponding first base image according to the corresponding relationship between the second channel identifier and the identifier of the base image.

In some embodiments, in response to the second rendering node comprising a third rendering child node, and a number of a channel of the third rendering child node being greater than the number of the channel of the second rendering child node, the effect rendering module is specifically configured to:

after performing effect rendering on the bound first base image based on a corresponding channel of the third rendering child node, preform effect rendering on the bound first base image based on the corresponding channel of the second rendering child node.

The configuration apparatus in the present embodiment is presented in the form of a functional unit, and the unit here refers to an ASIC (Application Specific Integrated Circuit) circuit, processor and memory that execute one or more software or fixed programs, and/or other apparatus that can provide the above-described functions.

The effect rendering apparatus of the present disclosure has the same beneficial effects as the above-described effect rendering method, which will not be described herein.

At least embodiment of the present disclosure further provides an electronic device, which includes the effect rendering apparatus shown in FIG. 11.

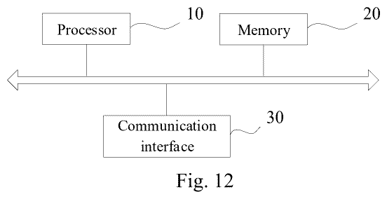

Referring to FIG. 12, FIG. 12 is a schematic structural diagram of an electronic device provided by at least one embodiment of the present disclosure. As shown in FIG. 12, the electronic device includes: one or more processors 10, a memory 20, and interfaces for connecting various components, including a high-speed interface and a low-speed interface. Various components are in communication connection with each other by using different buses and can be installed on a common motherboard or in other manners as required. The processor may process instructions executed within the electronic device, and the instructions include instructions stored in the memory or on the memory to display graphic information of a GUI on an external input/output apparatus (such as a display device coupled to the interface). In some optional implementations, a plurality of processors and/or a plurality of buses may be used together with a plurality of memories, if required. Similarly, a plurality of electronic devices may be connected, and each device provides part of necessary operations (for example, as a server array, a group of blade servers, or a multi-processor system). In FIG. 12, one processor 10 is taken as an example.

The processor 10 may be a central processing unit, a network processor, or a combination thereof. The processor 10 may further include a hardware chip. The above hardware chip may be an application specific integrated circuit, a programmable logic device, or a combination thereof. The above programmable logic device may be a complex programmable logic device, a field programmable logic gate array, a generic array logic, or any combination thereof.

The memory 20 stores instructions that can be executed by at least one processor 10 to enable the at least one processor 10 to perform the method shown in the above embodiments.

The memory 20 may include a program storage region and a data storage region, where the program storage region may store an operating system and applications required for at least one function; and the data storage region may store data created according to the use of the electronic device. In addition, the memory 20 may include a high-speed random access memory, and may also include a non-transitory memory, such as at least one magnetic disk storage device, a flash memory device, or other non-transitory solid-state storage device. In some optional implementations, the memory 20 may optionally include a memory remotely provided relative to the processor 10, and these remote memories may be connected to the electronic device through a network. Examples of the above network include but are not limited to the Internet, an intranet, a local area network, a mobile communication network, and a combination thereof.

The memory 20 may include a volatile memory, such as a random access memory; the memory may also include a non-volatile memory, such as a flash memory, a hard disk or a solid-state disk; and the memory 20 may also include a combination of the above-mentioned types of memories.

The electronic device further includes a communication interface 30 for the electronic device to communicate with other devices or communication networks.

The embodiments of the present disclosure further provide a computer-readable storage medium, the method according to the embodiments of the present disclosure may be implemented in hardware and firmware, or may be implemented as computer code that can be recorded in a storage medium, or may be implemented as computer code downloaded over a network, which is originally stored in a remote storage medium or a non-transitory machine-readable storage medium and will be stored in a local storage medium, so that the method described herein may be stored in such software processing on a storage medium using a general-purpose computer, a special-purpose processor, or programmable or special-purpose hardware. The storage medium may be a magnetic disk, an optical disk, a read-only memory, a random access memory, a flash memory, a hard disk, a solid-state disk, or the like; further, the storage medium may also include a combination of the above-mentioned types of memories. It can be understood that a computer, a processor, a microprocessor controller, or programmable hardware includes a storage component that can store or receive software or computer code, and when the software or computer code is accessed and executed by the computer, the processor, or the hardware, the method shown in the above embodiments is implemented.

A part of the present disclosure may be applied as a computer program product, such as computer program instructions, which, when executed by a computer, can call or provide the method and/or technical solutions according to the present disclosure through the operation of the computer. Those of ordinary skills in the art should understand that the existence form of computer program instructions in a computer-readable medium includes but is not limited to source files, executable files, installation package files, etc. Correspondingly, the manner in which the computer program instructions are executed by the computer includes but is not limited to: the computer directly executes the instructions, or the computer compiles the instructions and then executes the corresponding compiled program, or the computer reads and executes the instructions, or the computer reads and installs the instructions and then executes the corresponding installed program. Here, the computer-readable medium may be any available computer-readable storage medium or communication medium that can be accessed by the computer.

Although the embodiments of the present disclosure have been described with reference to the drawings, those of ordinary skills in the art may make various modifications and variations without departing from the spirit and scope of the present disclosure, and such modifications and variations fall within the scope defined by the appended claims.

1. An effect rendering method, comprising:
obtaining an image and a first effect rendering mode, wherein the first effect rendering mode is configured to specify a number of a base image and an identifier of the base image corresponding to first effect rendering, a number of a channel and a first channel identifier of each first rendering node of the first effect rendering, and a corresponding relationship between the first channel identifier and the identifier of the base image;
generating a plurality of first base images based on the image and the number of the base image, and identifying the first base images in one-to-one correspondence through the identifiers of the base images;
binding the channel of each first rendering node to a corresponding first base image according to the corresponding relationship between the first channel identifier and the identifier of the base image;
performing effect rendering on the bound first base image based on a corresponding channel of the first rendering node to obtain a rendering result.

2. The method according to claim 1, wherein in response to the first rendering node comprising a first channel and a second channel other than the first channel, the performing effect rendering on the bound first base image based on a corresponding channel of the first rendering node comprises:
performing effect rendering on a first base image bound to the first channel based on the first channel;
stopping effect rendering on a first base image bound to the second channel based on the second channel;
copying the first base image bound to the first channel, and using a copied first base image as a first base image obtained by performing effect rendering on the first base image bound to the second channel based on the second channel;
replacing the first base image bound to the second channel with the copied first base image.

3. The method according to claim 1, wherein in response to the first rendering node comprising a first rendering child node and a second rendering child node, and a number of a channel of the first rendering child node being greater than a number of a channel of the second rendering child node, the performing effect rendering on the bound first base image based on a corresponding channel of the first rendering node comprises:
after performing effect rendering on the bound first base image based on a corresponding channel of the first rendering child node, performing effect rendering on the bound first base image based on a corresponding channel of the second rendering child node.

4. The method according to claim 3, further comprising:
obtaining a second effect rendering mode, wherein the second effect rendering mode is configured to specify each second rendering node of second effect rendering;
binding a channel of the second rendering node to at least a portion of the first base images;
performing effect rendering on the bound first base image based on the channel of the second rendering node.

5. The method according to claim 4, wherein the binding a channel of the second rendering node to at least a portion of the first base images comprises:
in response to the second effect rendering mode not specifying a number of a channel and a second channel identifier of each second rendering node, and a corresponding relationship between the second channel identifier and the identifier of the base image, binding the channels of the second rendering node in one-to-one correspondence with all of the first base images.

6. The method according to claim 5, wherein the performing effect rendering on the bound first base image based on the channel of the second rendering node comprises:
after performing effect rendering on the bound first base image based on the channel of the second rendering node, performing effect rendering on the bound first base image based on the corresponding channel of the second rendering child node.

7. The method according to claim 4, wherein the binding a channel of the second rendering node to at least a portion of the first base images comprises:
in response to the second effect rendering mode having specified a number of a channel and a second channel identifier of each second rendering node, and a corresponding relationship between the second channel identifier and the identifier of the base image, binding the channel of the each second rendering node to a corresponding first base image according to the corresponding relationship between the second channel identifier and the identifier of the base image.

8. The method according to claim 7, wherein in response to the second rendering node comprising a third rendering child node, and a number of a channel of the third rendering child node being greater than the number of the channel of the second rendering child node, the performing effect rendering on the bound first base image based on the channel of the second rendering node comprises:
after performing effect rendering on the bound first base image based on a corresponding channel of the third rendering child node, performing effect rendering on the bound first base image based on the corresponding channel of the second rendering child node.

9. An electronic device, comprising:
a memory and a processor, wherein the memory and the processor are in communication connection with each other, the memory stores computer instructions, and the processor executes the computer instructions to perform an effect rendering method, and the effect rendering method comprises:
obtaining an image and a first effect rendering mode, wherein the first effect rendering mode is configured to specify a number of a base image and an identifier of the base image corresponding to first effect rendering, a number of a channel and a first channel identifier of each first rendering node of the first effect rendering, and a corresponding relationship between the first channel identifier and the identifier of the base image;
generating a plurality of first base images based on the image and the number of the base image, and identifying the first base images in one-to-one correspondence through the identifiers of the base images;
binding the channel of each first rendering node to a corresponding first base image according to the corresponding relationship between the first channel identifier and the identifier of the base image;
performing effect rendering on the bound first base image based on a corresponding channel of the first rendering node to obtain a rendering result.

10. The electronic device according to claim 9, wherein in response to the first rendering node comprising a first channel and a second channel other than the first channel, the performing effect rendering on the bound first base image based on a corresponding channel of the first rendering node comprises:
performing effect rendering on a first base image bound to the first channel based on the first channel;
stopping effect rendering on a first base image bound to the second channel based on the second channel;
copying the first base image bound to the first channel, and using a copied first base image as a first base image obtained by performing effect rendering on the first base image bound to the second channel based on the second channel;
replacing the first base image bound to the second channel with the copied first base image.

11. The electronic device according to claim 9, wherein in response to the first rendering node comprising a first rendering child node and a second rendering child node, and a number of a channel of the first rendering child node being greater than a number of a channel of the second rendering child node, the performing effect rendering on the bound first base image based on a corresponding channel of the first rendering node comprises:
after performing effect rendering on the bound first base image based on a corresponding channel of the first rendering child node, performing effect rendering on the bound first base image based on a corresponding channel of the second rendering child node.

12. The electronic device according to claim 11, further comprising:
obtaining a second effect rendering mode, wherein the second effect rendering mode is configured to specify each second rendering node of second effect rendering;
binding a channel of the second rendering node to at least a portion of the first base images;
performing effect rendering on the bound first base image based on the channel of the second rendering node.

13. The electronic device according to claim 12, wherein the binding a channel of the second rendering node to at least a portion of the first base images comprises:
in response to the second effect rendering mode not specifying a number of a channel and a second channel identifier of each second rendering node, and a corresponding relationship between the second channel identifier and the identifier of the base image, binding the channels of the second rendering node in one-to-one correspondence with all of the first base images.

14. The electronic device according to claim 13, wherein the performing effect rendering on the bound first base image based on the channel of the second rendering node comprises:
after performing effect rendering on the bound first base image based on the channel of the second rendering node, performing effect rendering on the bound first base image based on the corresponding channel of the second rendering child node.

15. The electronic device according to claim 12, wherein the binding a channel of the second rendering node to at least a portion of the first base images comprises:
in response to the second effect rendering mode having specified a number of a channel and a second channel identifier of each second rendering node, and a corresponding relationship between the second channel identifier and the identifier of the base image, binding the channel of the each second rendering node to a corresponding first base image according to the corresponding relationship between the second channel identifier and the identifier of the base image.

16. The electronic device according to claim 15, wherein in response to the second rendering node comprising a third rendering child node, and a number of a channel of the third rendering child node being greater than the number of the channel of the second rendering child node, the performing effect rendering on the bound first base image based on the channel of the second rendering node comprises:
after performing effect rendering on the bound first base image based on a corresponding channel of the third rendering child node, performing effect rendering on the bound first base image based on the corresponding channel of the second rendering child node.

17. A non-transitory computer-readable storage medium, storing computer instructions, wherein the computer instructions are used to enable a computer to perform an effect rendering method, and the effect rendering method comprises:
obtaining an image and a first effect rendering mode, wherein the first effect rendering mode is configured to specify a number of a base image and an identifier of the base image corresponding to first effect rendering, a number of a channel and a first channel identifier of each first rendering node of the first effect rendering, and a corresponding relationship between the first channel identifier and the identifier of the base image;
generating a plurality of first base images based on the image and the number of the base image, and identifying the first base images in one-to-one correspondence through the identifiers of the base images;
binding the channel of each first rendering node to a corresponding first base image according to the corresponding relationship between the first channel identifier and the identifier of the base image;
performing effect rendering on the bound first base image based on a corresponding channel of the first rendering node to obtain a rendering result.

18. The non-transitory computer-readable storage medium according to claim 17, wherein in response to the first rendering node comprising a first channel and a second channel other than the first channel, the performing effect rendering on the bound first base image based on a corresponding channel of the first rendering node comprises:
performing effect rendering on a first base image bound to the first channel based on the first channel;
stopping effect rendering on a first base image bound to the second channel based on the second channel;
copying the first base image bound to the first channel, and using a copied first base image as a first base image obtained by performing effect rendering on the first base image bound to the second channel based on the second channel;
replacing the first base image bound to the second channel with the copied first base image.

19. The non-transitory computer-readable storage medium according to claim 17, wherein in response to the first rendering node comprising a first rendering child node and a second rendering child node, and a number of a channel of the first rendering child node being greater than a number of a channel of the second rendering child node, the performing effect rendering on the bound first base image based on a corresponding channel of the first rendering node comprises:
after performing effect rendering on the bound first base image based on a corresponding channel of the first rendering child node, performing effect rendering on the bound first base image based on a corresponding channel of the second rendering child node.

20. The non-transitory computer-readable storage medium according to claim 19, further comprising:
obtaining a second effect rendering mode, wherein the second effect rendering mode is configured to specify each second rendering node of second effect rendering;
binding a channel of the second rendering node to at least a portion of the first base images;
performing effect rendering on the bound first base image based on the channel of the second rendering node.
